(19) United States
(12) Patent Application Publication
(10) Pub. No.: US 2010/0199534 A1
(43) Pub. Date: Aug. 12, 2010

(54) GRAB BAR SIGN MOUNT

(75) Inventors: Christopher M. Larsen, Farmington Hills, MI (US); Michael J. Kelly, Bloomingdale, IL (US)

Correspondence Address: HARNESS, DICKEY & PIERCE, P.L.C., P.O. BOX 828, BLOOMFIELD HILLS, MI, 48303, US

(73) Assignee: Marketing Displays, Inc., Farmington Hills, MI (US)

(21) Appl. No.: 12/704,671

(22) Filed: Feb. 12, 2010

Related U.S. Application Data
(60) Provisional application No. 61/152,053, filed on Feb. 12, 2009.

(51) Int. Cl. G09F 21/04; G09F 15/00

(52) U.S. Cl. 40/591; 40/606.01

(57) ABSTRACT

A system for mounting a sign to a vehicle includes a bar connected to the vehicle. A clamp assembly includes first and second jaw members adapted to frictionally engage the bar between the first and second jaw members. At least one structural member supports the first and second jaw members. A sign assembly includes a support frame having the at least one structural member connected to the support frame. A frame member is slidably received by and releasably engaged to the support frame. A sign connected to the frame member is adapted to be positioned in each of a stowed and a deployed position.

### CROSS-REFERENCE TO RELATED APPLICATIONS

This application claims the benefit of U.S. Provisional Application No. 61/152,053, filed on Feb. 12, 2009. The entire disclosure of the above application is incorporated herein by reference.

### FIELD

The present disclosure relates to sign mounting devices used for mounting warning and public information signs to a vehicle.

### BACKGROUND

This section provides background information related to the present disclosure which is not necessarily prior art.

Portable self standing signs are available for automotive and truck use for example during emergencies and at accident locations which are used to warn other motorists of the conditions, to direct traffic onto an alternate route, or the like. Service vehicles such as telephone, gas, water, television, or electrical trucks or vans also use self standing signs, cones, flashing beacons, and the like for similar purposes and which are commonly required when the service vehicle blocks a portion of a street or through-way.

Portable self standing devices of this type can be damaged, run over, forgotten at the sight, or in other ways commonly lost requiring frequent replacement. Such devices also require their own designated storage space such as in a storage rack, in a trunk, or in a bin provided for this purpose. Provision of the designated storage space limits the otherwise available space for other equipment such as tools, hoses, machines, and the like.

### SUMMARY

This section provides a general summary of the disclosure, and is not a comprehensive disclosure of its full scope or all of its features.

According to several embodiments of a grab bar sign mount of the present disclosure, a system for mounting a sign to a vehicle includes a bar connected to the vehicle. A clamp assembly includes first and second jaw members adapted to frictionally engage the bar between the first and second jaw members. At least one structural member supports the first and second jaw members. A sign assembly includes a support frame having the at least one structural member connected to the support frame. A frame member is slidably received by and releasably engaged to the support frame. A sign connected to the frame member is adapted to be positioned in each of a stowed and a deployed position.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of a grab bar sign-holder of the present disclosure having a clamp assembly for mounting a sign to a grab bar;

FIG. 2 is a front right perspective view of the mounted clamp assembly and bar of FIG. 1;

FIG. 3 is a front left perspective view of the clamp assembly and sign frame of FIG. 1;

FIG. 4 is a top plan view of the clamp assembly and sign frame of FIG. 1;

FIG. 5 is a front elevational view of the clamp assembly and sign frame of FIG. 1;

FIG. 6 is a front elevational view of the assembly of FIG. 1;

FIG. 7 is a front left perspective view of second clamp assembly and sign frame of the present disclosure;

FIG. 8 is a top plan view of the clamp assembly and sign frame of FIG. 7;

FIG. 9 is a rear elevational view of second clamp assembly and sign frame of FIG. 7;

FIG. 10 is a front left perspective view of a third clamp assembly and sign frame of the present disclosure;

FIG. 11 is a front right perspective view of the third clamp assembly and sign frame of FIG. 10;

FIG. 12 is a top plan view of the third clamp assembly and sign frame of FIG. 10;

FIG. 13 is a front left perspective view looking rearward of a fourth clamp assembly for mounting a sign to a grab bar of the present disclosure;

FIG. 14 is a front left perspective view looking forward of the fourth clamp assembly of FIG. 13;

FIG. 15 is a left rear perspective view of the third clamp assembly connected to a sign assembly in a stowed condition prior to installation of the clamp assembly to the bar;

FIG. 16 is a right rear perspective view further showing the third clamp assembly of FIG. 15 in a clamp installed position on the bar;

FIG. 17 is the right rear perspective view of FIG. 17 further showing the sign in the fully deployed position; and

FIG. 18 is a left rear perspective view of an emergency vehicle having a mounted clamp assembly with a fully deployed sign of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

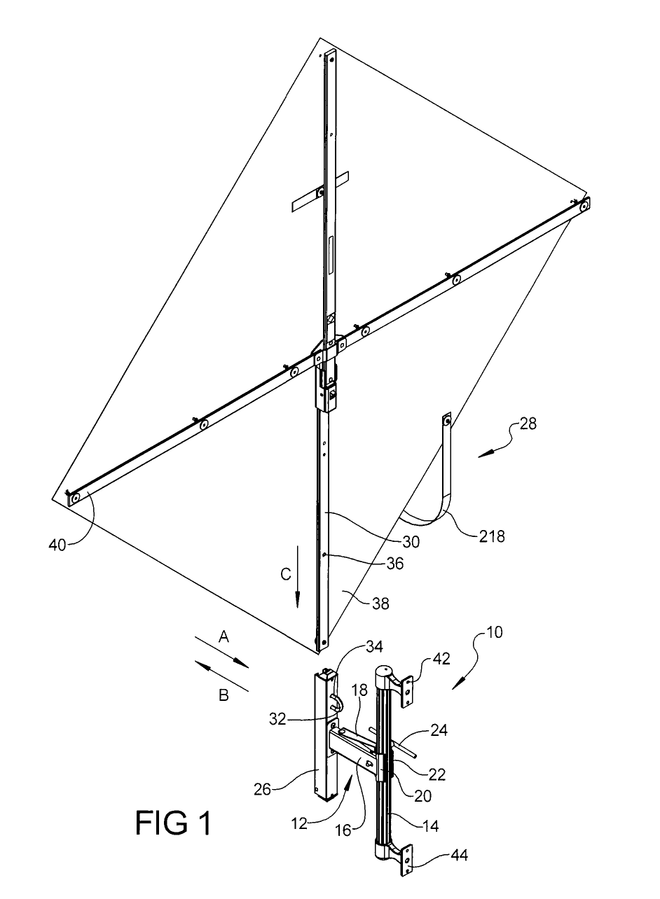

Referring to FIG. 1, a grab bar sign holder 10 includes a first clamp assembly 12 which can be frictionally and releasably connected or permanently coupled to a bar 14. First clamp assembly 12 includes a fixed clamp member 16 and a moving clamp member 18. A first jaw member 20 is connected such as by welding to fixed clamp member 16. A second jaw member 22 is connected such as by welding to moving clamp member 18. First and second jaw members 20, 22 are aligned when positioned in a rotated position to grasp bar 14. A locking member 24 is used to displace moving clamp member 18 with respect to fixed clamp member 16 to couple bar 14 between the first and second jaw members 20, 22.

Fixed clamp member 16 is connected either releasably or permanently to a support frame 26. According to several embodiments, support frame 26 is an aluminum extruded member. Support frame 26 is adapted to receive and releasably support a sign assembly 28. Sign assembly 28 can include a first sign frame member 30 which is adapted to be slidably received in support frame 26.

To slidably connect first sign frame member 30 with support frame 26, an engagement device 32 having an engagement member 34 is displaced in a retraction direction “A”. According to several embodiments, engagement device 32 is biased in a insertion direction “B” such that when first sign frame member 30 is slidably received in support frame 26 in a sign installation direction “C”, engagement device 32 is biased in the insertion direction “B” such that engagement member 34 is slidably received in a frame member aperture 36 of first sign frame member 30. Engagement of engagement member 34 in frame member aperture 36 retains sign assembly 28 until engagement device 32 is once again moved in the retraction direction “A” to release engagement member 34 from frame member aperture 36. An exemplary engagement device 32 is disclosed in U.S. Pat. No. 7,458,554 to Levin et al., owned by the assignee of the present disclosure, the subject matter of which is incorporated herein by reference.

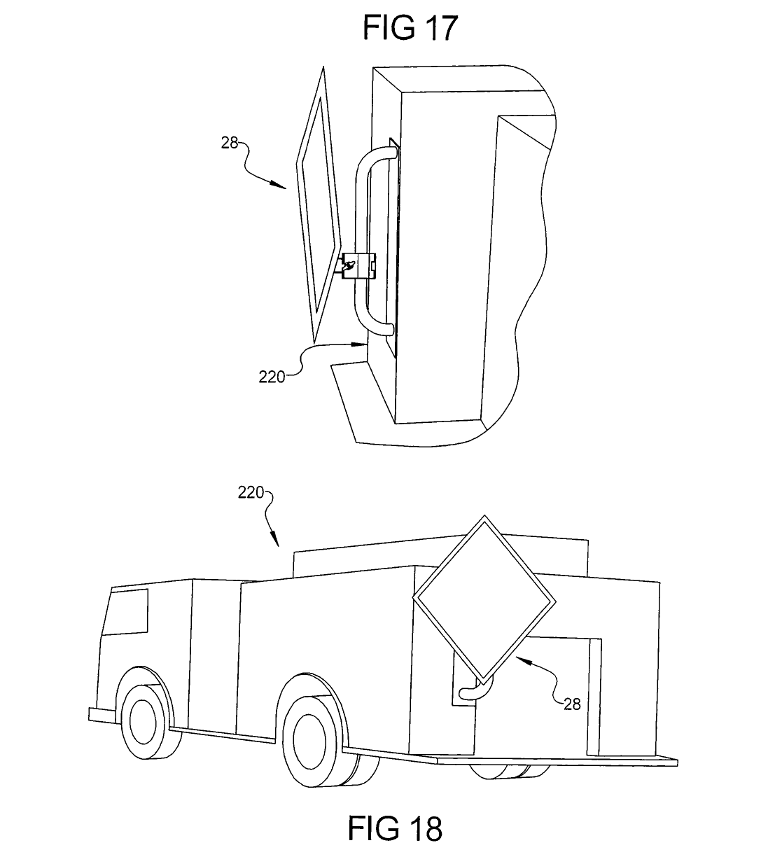

Sign assembly 28 can further include a sign 38 which is commonly made of a flexible, polymeric or fiber material such that sign 38 can be folded or stowed and subsequently elastically or flexibly extended to a fully deployed position shown. A second sign frame member 40 which can be positioned transverse to or at an angle with respect to first sign frame member 30 is provided to retain sign 38 in the fully deployed position. Second sign frame member 40 is commonly foldable, rotatable, and/or releasably engaged with respect to first sign frame member 30 to allow sign 38 to be positioned in the stowed position shown and described in reference to FIGS. 17 and 18. An exemplary sign assembly 28 is disclosed in U.S. Pat. No. 6,606,809 to Hillstrom et al., owned by the assignee of the present disclosure, the subject matter of which is incorporated herein by reference.

Bar 14 can be a totally self contained member connected to a vehicle (shown and described in reference to FIG. 18). First and second bar attachment devices 42, 44 can also be fixedly connected to bar 14 to provide additional support between bar 14 and the vehicle. Bar 14 can be in the form of a grab bar, commonly used by occupants to enter or depart from the vehicle, or bar 14 can also be any similarly configured tubing, bar, and/or structural member attached to the vehicle for other applications such as but not limited to roof racks.

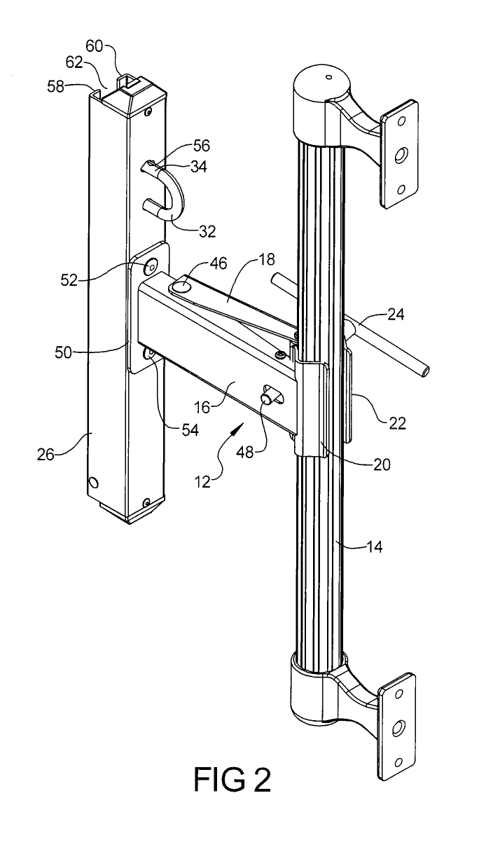

Referring to FIG. 2, according to several embodiments the moving clamp member 18 is rotatably connected to fixed clamp member 16 using a pin 46. Pin 46 can be in the form of a rivet, a fastener such as a bolt and nut combination, or a pin and clip combination within the scope of the present disclosure. Locking member 24 can include a threaded engagement portion 48 which is threadably received in at least the fixed clamp member 16 and according to other embodiments also to the moving clamp member 18 such that rotation of locking member 24 rotates moving clamp member 18 about an axis defined by pin 46 to engage bar 14 between each of the first and second jaw members 20, 22. Fixed clamp member 16 can further include a mounting flange 50 which is used to connect first clamp assembly 12 to support frame 26. Connection of mounting flange 50 can be assisted through the use of first and second fasteners 52, 54 such as rivets or screws. According to other embodiments first and second fasteners 52, 54 are omitted and mounting flange 50 can be fixedly connected to support frame 26 such as by welding. If a welded connection is used, support frame 26 and at least fixed clamp member 16 are provided of the same material such as a metal including steel or aluminum.

With further reference to Both FIGS. 1 and 2, engagement member 34 of engagement device 32 is slidably received in an engagement member clearance bore 56 created through support frame 26. According to several embodiments support frame 26 is an extrusion made of a single piece of metal material such as aluminum, with the extrusion including each of a first and second extending wall 58, 60. A frame member receiving slot 62 is created between first and second extending walls 58, 60 which is adapted to slidably receive the first sign frame member 30.

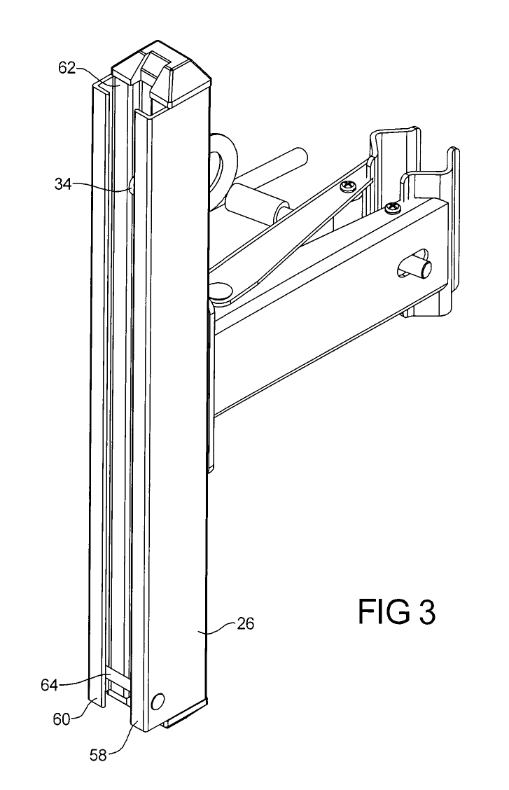

Referring to FIG. 3, a fastener 64 such as a rivet, bolt, or screw can be inserted through each of first and second extending walls 58, 60 to create a physical stop point in frame member receiving slot 62. As more clearly shown in this view, engagement member 34 is normally biased such that engagement member 34 extends at least partially through frame member receiving slot 62.

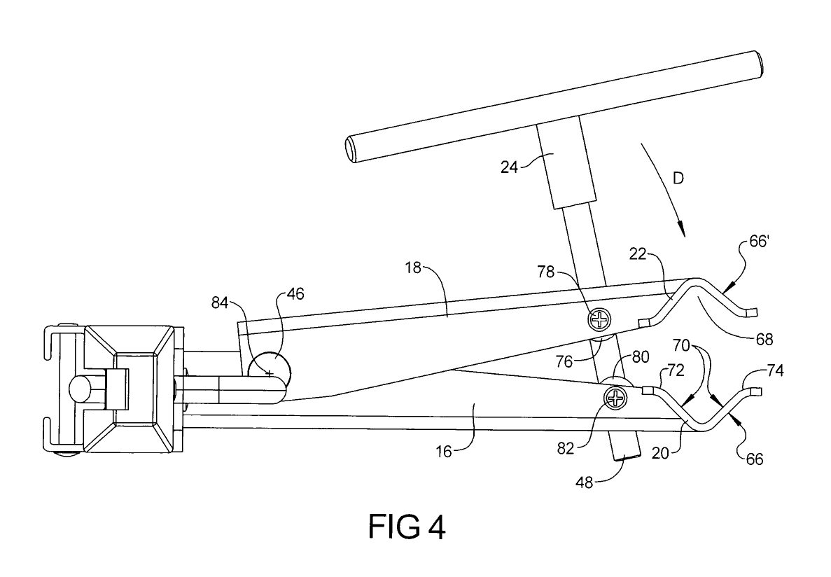

Referring to FIG. 4 and again to FIG. 1, each of the first and second jaw members 20, 22 can include a geometrically shaped body such as a V-shaped body 66, 66′, each therefore defining a V-shaped bar receiving cavity 68. Each of the first and second jaw members 20, 22 further include curved inner facing wall segments 70 which diverge into each of a first and second concave transition portion 72, 74. A curved or rounded geometry provided by curved inner facing wall segment 70 and the first and second concave transition portions 72, 74 are provided to ensure at least two points of contact for each of the first and second jaw members 20, 22 during engagement with the bar 14. A first threaded-bore barrel 76 is connected using a first barrel fastener 78 to moving clamp member 18. Similarly, a second threaded-bore barrel 80 is connected to fixed clamp member 16 using a second barrel fastener 82. Each of the first and second threaded-bore barrels 76, 80 can include a threaded bore (not shown) adapted to threadably receive the threaded engagement portion 48 of locking member 24. Rotation of locking member 24 axially rotates the threaded engagement portion 48 to translate moving clamp member 18 with respect to fixed clamp member 16 to either open or close the first and second jaw members 20, 22. Moving clamp member 18 rotates with respect to fixed clamp member 16 about a pin longitudinal axis 84 of pin 46. For example only, if right-hand threads are used for threaded engagement portion 48 a clockwise rotation of locking member 24 will cause moving clamp member 18 to rotate about a jaw closure arc “D” with respect to longitudinal axis 84.

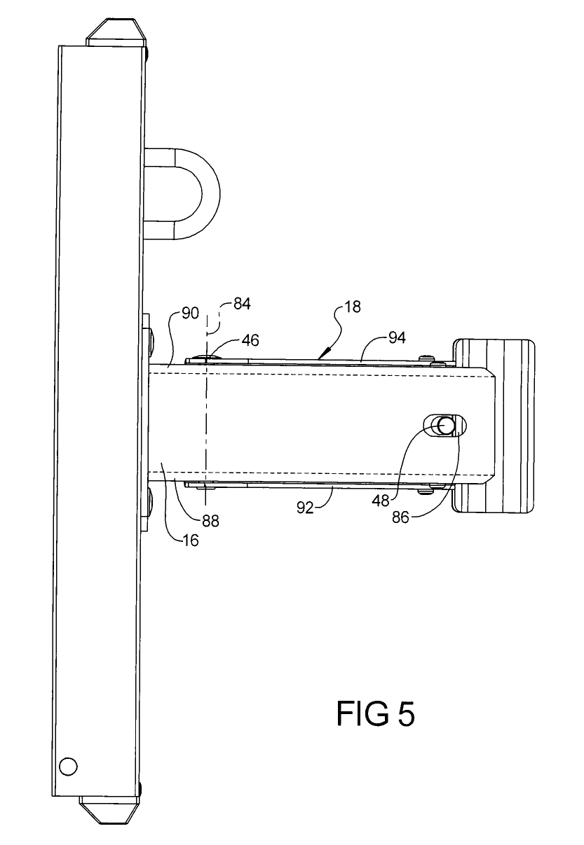

Referring to FIG. 5, it is desirable that pin 46 extend entirely through each of a first and second clamp flange wall 88, 90 of fixed clamp member 16 and a third and fourth clamp flange wall 92, 94 of moving clamp member 18. According to several embodiments third and fourth clamp flange walls 92, 94 are spaced further apart than a spacing between first and second clamp flange walls 88, 90 so that at least a portion of first and second clamp flange walls 88, 90 are received between third and fourth clamp flange walls, 92, 94. An elongated aperture 86 can be provided through a flange or flat portion of fixed clamp member 16 to allow for an angular displacement of threaded engagement portion 48 as moving clamp member 18 rotates with respect to fixed clamp member 16 about pin longitudinal axis 84.

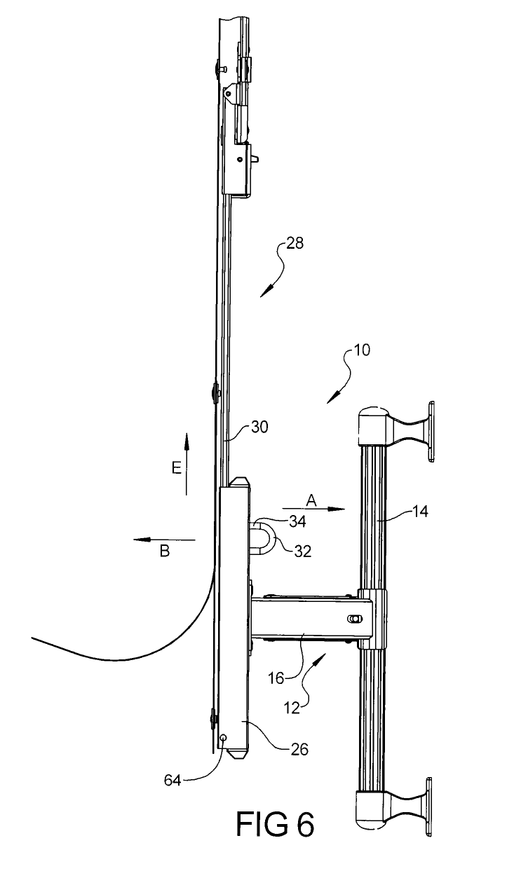

Referring to FIG. 6, first sign frame member 30 is shown in its installed position within support frame 26, with engagement member 34 biased in the insertion direction “B”. In the installed position, first sign frame member 30 can contact the fastener 64 providing a maximum depth of insertion of first sign member 30. Also in the installed position, because engagement member 34 is biased in the insertion direction “B” first sign frame member 30 is prevented from release in a frame member release direction “E” unless and until engagement device 32 is moved in the retraction direction “A”. In the fully installed position of both first clamp assembly 12 and sign assembly 28, first sign frame member 30 is non-rotatably coupled to support frame 26. Support frame 26 is non-rotatably coupled to fixed clamp member 16 of first clamp assembly 12. First clamp assembly 12 is frictionally engaged to bar 14, thus the entire grab bar sign holder assembly 10 is non-rotatably engaged to bar 14. First clamp assembly 12 can also be vertically positioned at any location along a length of bar 14. This vertical placement can be used for example to increase or decrease an overall height of sign assembly 28. Alternatively, if bar 14 is oriented horizontally instead of vertically, first clamp assembly 12 allows the entire sign assembly 28 to be moved in a horizontal direction with respect to bar 14.

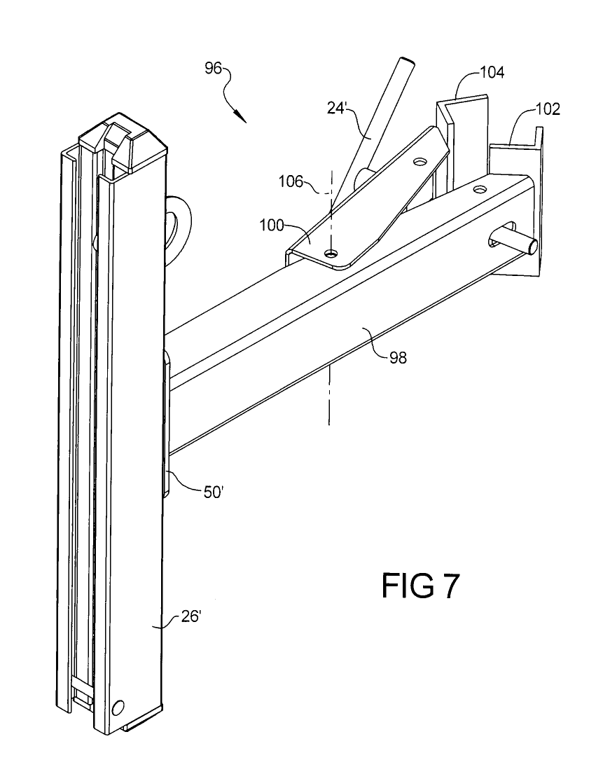

Referring to FIG. 7, according to several embodiments a second clamp assembly 96 is modified from first clamp assembly 12. Second clamp assembly 96 can include a fixed clamp member 98 and a moving clamp member 100 rotatably connected to fixed clamp member 98. Fixed clamp member 98, similar to fixed clamp member 16 of first clamp assembly 12, can be connected to a support frame 26′ using a mounting flange 50′ or welded directly to support frame 26′. Second clamp assembly 96 further includes each of an L-shaped first jaw member 102 and an L-shaped second jaw member 104, the L-shape being a variant within the scope of the V-shape previously described herein, having a first leg equal in length or longer than a second leg. The geometry of L-shaped first and second jaw members 102, 104 allows these members to be cut from L-shaped stock material to any length desired and then fixed for example by welding to either the fixed clamp member 98 or moving clamp member 100. L-shaped first and second jaw members 102, 104 are also movable toward or away from each other by rotation about a clamp member axis of rotation 106. A locking member 24′ can also be provided to positively reposition L-shaped second jaw member 104 with respect to L-shaped first jaw member 102.

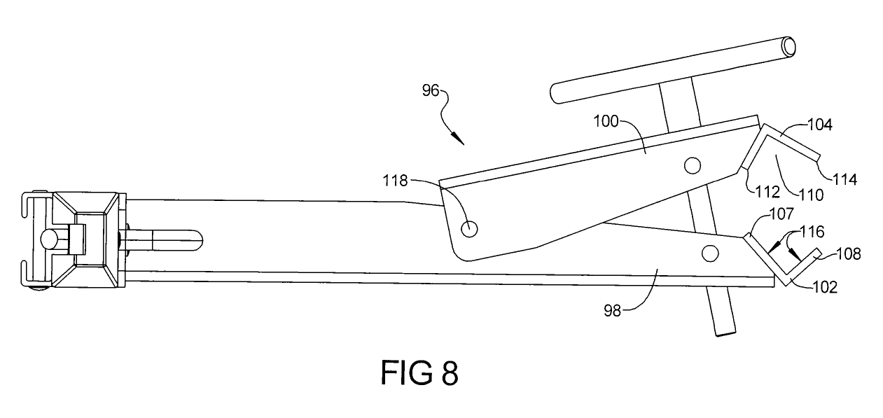

Referring to FIG. 8, L-shaped first and second jaw members 102, 104 each commonly include a first jaw portion 107 and a second jaw portion 108 having second jaw portion 108 positioned at an angle such as a right angle with respect to first jaw portion 107. An L-shaped bar receiving cavity 110 is defined between first and second jaw portions 107, 108. Each of the first and second jaw portions 107, 108 also provide a first right angle transition portion 112 and a second right angle transition portion 114. Use of first and second right angle transition portions 112, 114 provides sharp corners that can engage extending or female features of a bar positioned between the first and second jaw portions 107, 108. Each of first and second jaw portions 107, 108 further includes a flat inner facing wall segment 116. Moving clamp member 100 is rotatably connected to fixed clamp member 98 using a pin 118.

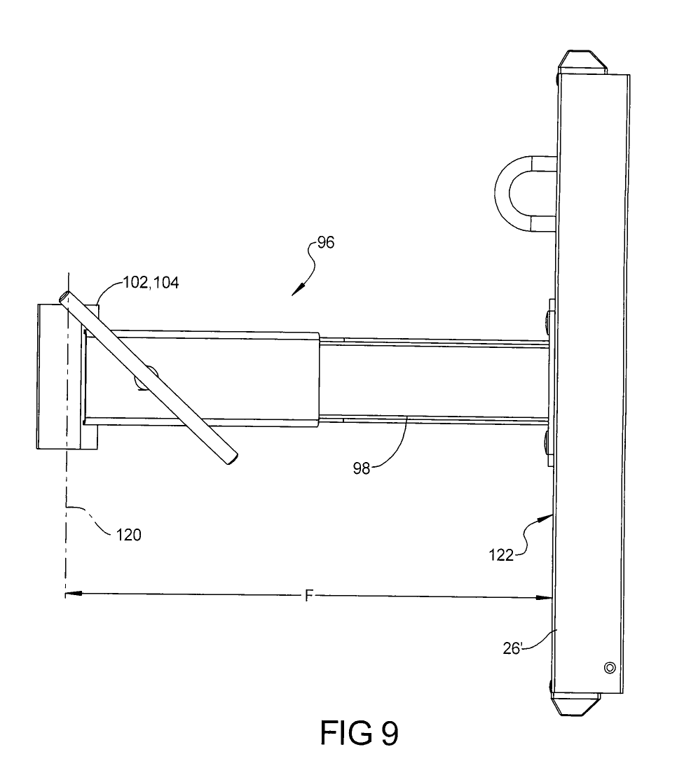

Referring to FIG. 9, a bar standoff dimension “F” is provided between a bar longitudinal axis 120 defined by L-shaped first and second jaw members 102, 104 and a contact face 122 of support frame 26′. Bar standoff dimension “F” can be increased or decreased by increasing or decreasing a length of fixed clamp member 98.

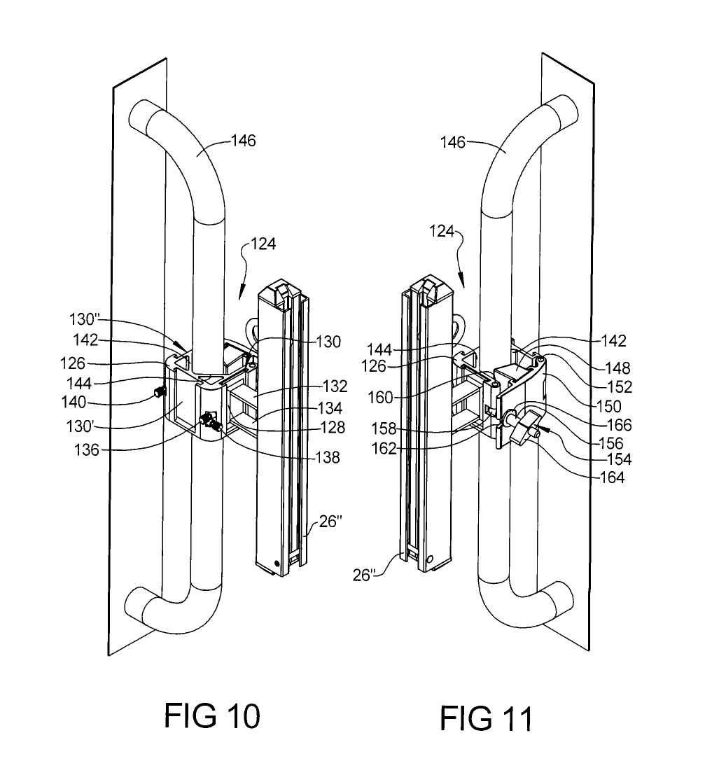

Referring to FIG. 10, a third clamp assembly 124 of the present disclosure is created using a formed or an extruded body 126 which can be made for example from an aluminum material. Body 126 is adapted to slidably receive a mounting flange 128 in a T-shaped slot 130 created in body 126. First and second mount brackets 132, 134 are fixedly connected to mounting flange 128 at a first end and to a support frame 26″ at a second end. Multiple ones of the T-shaped slots 130, shown for example as T-shaped slots 130′, 130″, are provided with body 126 to allow support frame 26″ to be oriented in at least three different orientations with respect to body 126. When the mounting flange 128 is received in one of the T-shaped slots 130, a fastener such as first, second, or third retention fasteners 136, 138, 140 are threadably engaged in body 126 to frictionally engage the mounting flange 128 frictionally restrict its removal.

Body 126 can also include first and second bar contact walls 142, 144 homogeneously provided with or welded to body 126. According to several embodiments, first and second bar contact walls 142, 144 are oriented at a 90 degree angle with respect to each other. This angle can also be modified at the discretion of the manufacturer to less than or greater than a 90 degree angle. A bar 146 is received within a cavity defined between first and second bar contact walls 142, 144. Bar 146 is frictionally retained by engagement with a bar engagement member 148. According to several embodiments, bar engagement member 148 is made from a material softer than a material of bar 146, such as a polymeric material, allowing bar engagement member 148 to deflect during contact with bar 146 thereby increasing a frictional engagement area of bar engagement member 148 about a perimeter of bar 146.

Bar engagement member 148 is slidably received in a clamp door 150. Clamp door 150 is rotatably connected to body 126 using a hinge pin 152. A fastener assembly 154 is also rotatably connected to body 126. Fastener assembly 154 can include a contact tube 156 which is slidably disposed with respect to a shank 158 of fastener assembly 154. Shank 158 is fixedly connected and transversely oriented with respect to a hinge pin member 160 which is rotatably received within body 126.

When clamp door 150 is rotated until bar engagement member 148 contacts bar 146, shank 158 is rotated through a shank clearance cavity 162 created in clamp door 150, positioning a handle 164 and washer 166 of fastener assembly 154 outside of the clamp door 150. Handle 164 can thereafter be rotated to increase a clamping force that clamp door 150 and bar engagement member 148 apply to bar 146. Handle 164 is rotated until bar engagement member 148 in frictional engagement with bar 146 prevents rotation of third clamp assembly 124 with respect to bar 146.

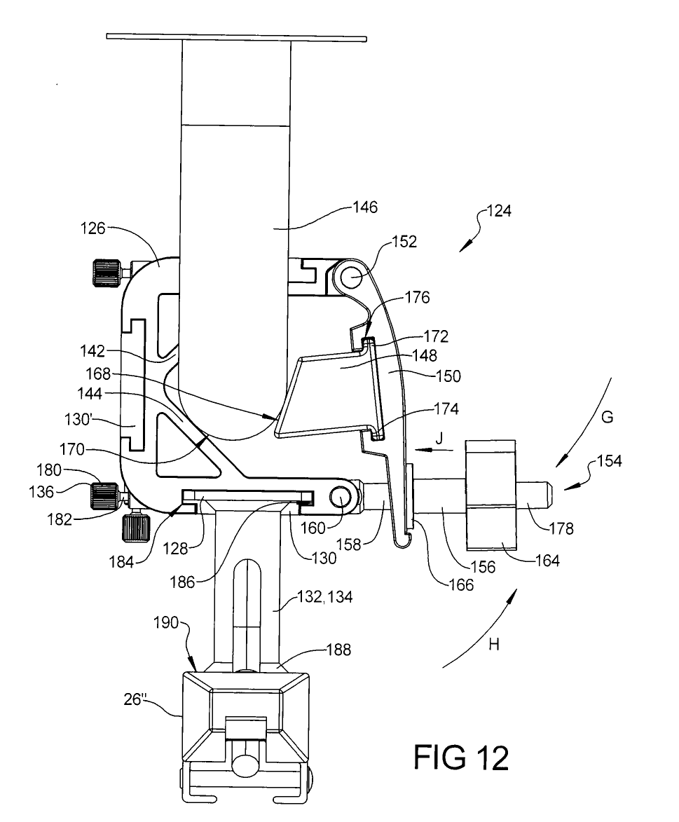

Referring to FIG. 12, bar engagement member 148 is provided with an engagement face 168 which is oriented at an acute angle with respect to clamp door 150 which permits use of bars 146 having multiple diameters. Engagement face 168 is oriented to contact a bar perimeter wall 170 of bar 146. Bar 146 is in further contact with each of first and second bar contact walls 142, 144 and the bar engagement member 148 to prevent rotation of third clamp assembly 124 with respect to bar 146.

Bar engagement member 148 can further include each of a first and second flange 172, 174 which are slidably received in a T-shaped slot 176 of clamp door 150. A fixed engagement of bar engagement member 148 within T-shaped slot 176 is not required because of the pressure applied to bar engagement member 148 during engagement with bar 146. Additional fasteners such as first retention fastener 136 are therefore not required to retain bar engagement member 148 in T-shaped slot 176.

A shank thread portion 178 is created at a free end of shank 158. A threaded bore (not shown) of handle 164 is threadably connected to shank thread portion 178. Rotation of handle 164 therefore pushes contact tube 156 into washer 166 in a door clamping direction “J” which compresses bar engagement member 148 against bar perimeter wall 170. According to several embodiments, handle 164, contact tube 156, and washer 166 can also be integrally connected. This compressive force applied to bar engagement member 148 is resisted by the hinge pin member 160 connected to body 126. As previously described, clamp door 150 is rotatable about hinge pin 152 such that clamp door 150 can rotate in a door closure arc “G”. Also, fastener assembly 154 is rotatably connected at hinge pin member 160 to body 126 such that fastener assembly 154 can rotate in a fastener engagement arc “H” to the position shown in FIG. 12. By loosening the handle 164 with respect to shank thread portion 178, clearance can be provided between washer 166 and clamp door 150 so that fastener assembly 154 can be swung free of clamp door 150 allowing removal of third clamp assembly 124 from bar 146.

Each of the first, second, and third retention fasteners 136, 138, 140 can be provided with a knurled face 180 to assist with manual rotation of the retention fasteners. A retention fastener threaded shank 182 is provided with each of the first, second, and third retention fasteners 136, 138, 140, so that retention fastener threaded shank 182 can frictionally contact a first flange face 184 of mounting flange 128. Further rotation of the retention fastener also engages a second flange face 186 of mounting flange 128 within the T-shaped slot 130. At the opposite end of the first and second mount brackets 132, 134 a weld joint 188 can be created to fixedly connect each of the first and second mount brackets 132, 134 individually to a contact face 190 of the support frame 26″. According to other embodiments, weld joint 188 can also be replaced or substituted by a flange as previously described with reference to first clamp assembly 12 shown and described in FIG. 1.

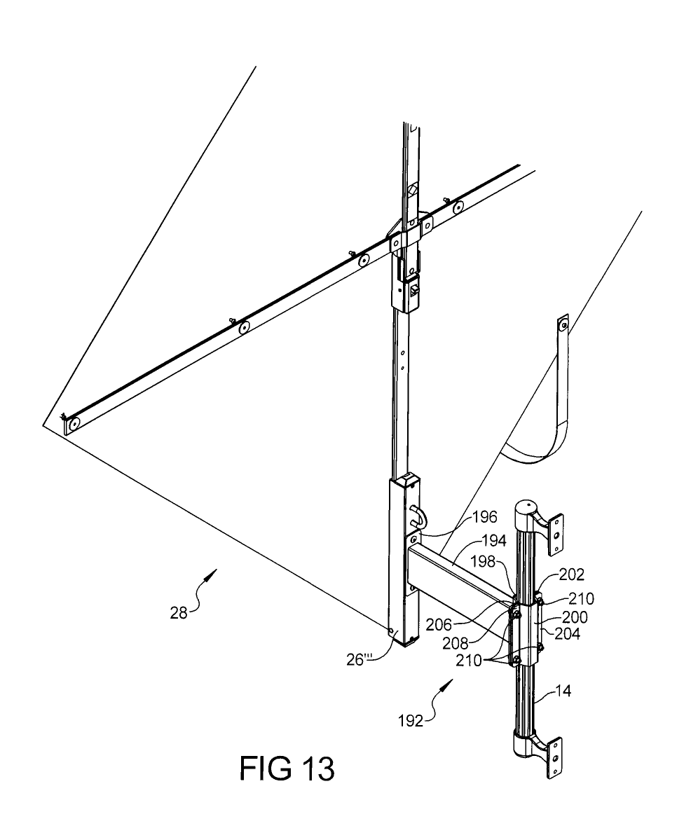

Referring to FIG. 13, a fourth clamp assembly 192 can be used to permanently fix sign assembly 28 with respect to bar 14. Fourth clamp assembly 192 includes a clamp leg 194 which is used in place of both the fixed and the moving clamp members of the previously described clamp assemblies. Clamp leg 194 can therefore be created from a rectangular or other geometrically-shaped tubing member or a circular-shaped pipe or tube. Clamp leg 194 is fixed for example by welding to a clamp mounting flange 196 which is in turn fixedly connected to a support frame 26′″. A first clamp jaw member 198 is fixedly connected to a free end of clamp leg 194. A second clamp jaw member 200 is fastenably connected to first clamp jaw member 198 to frictionally engage bar 14 between the first and second clamp jaw members 198, 200. A first coupling flange 202 of first clamp jaw member 198 is coupled to a second coupling flange 204 of second clamp jaw member 200 using a plurality of fasteners 210. Similarly, a third coupling flange 206 of first clamp jaw member 198 is coupled to a fourth coupling flange 208 of second clamp jaw member 200 also using a plurality of fasteners 210. Fourth clamp assembly 192 is therefore adapted to be permanently connected to bar 14.

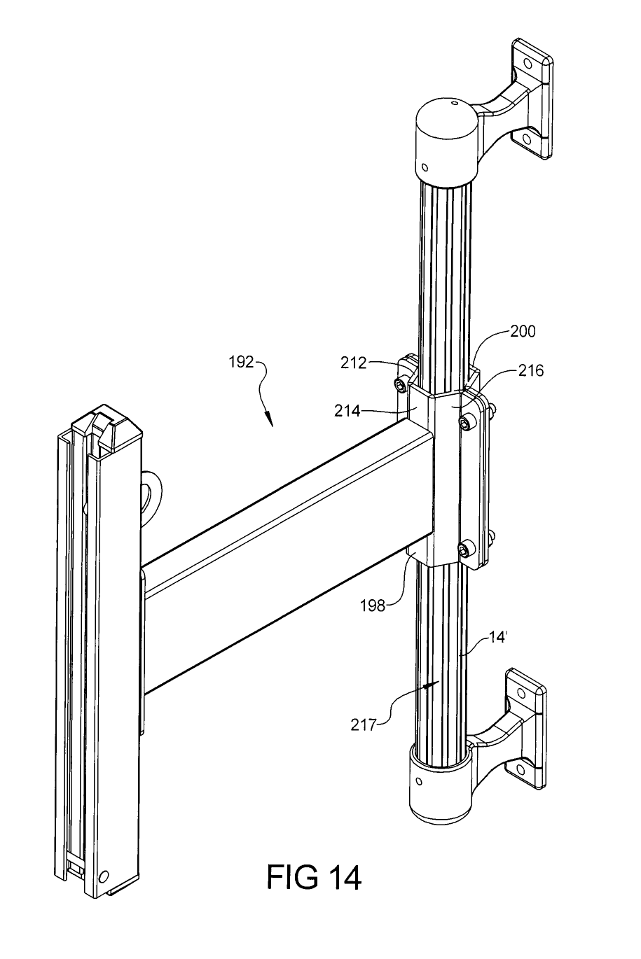

Referring to FIG. 14, each of the first and second clamp jaw members 198, 200 can further include, first, second and third jaw portions 212, 214, 216 which are oriented at different angles with respect to each other. The first, second, and third jaw portions 212, 214, 216 can be oriented to abut with individual ones of a plurality of bar faces 217 created about a perimeter of bar 14′. This contact between first, second, and third jaw portions 212, 214, 216 therefore further inhibits rotation of fourth clamp assembly 192 with respect to bar 14′.

Referring to FIG. 15, a sign assembly 28 is shown connected to third clamp assembly 124 having sign assembly 28 in its stowed position retained by a flexible sign strap 218. Third clamp assembly 124 is shown prior to installation on a vehicle 220.

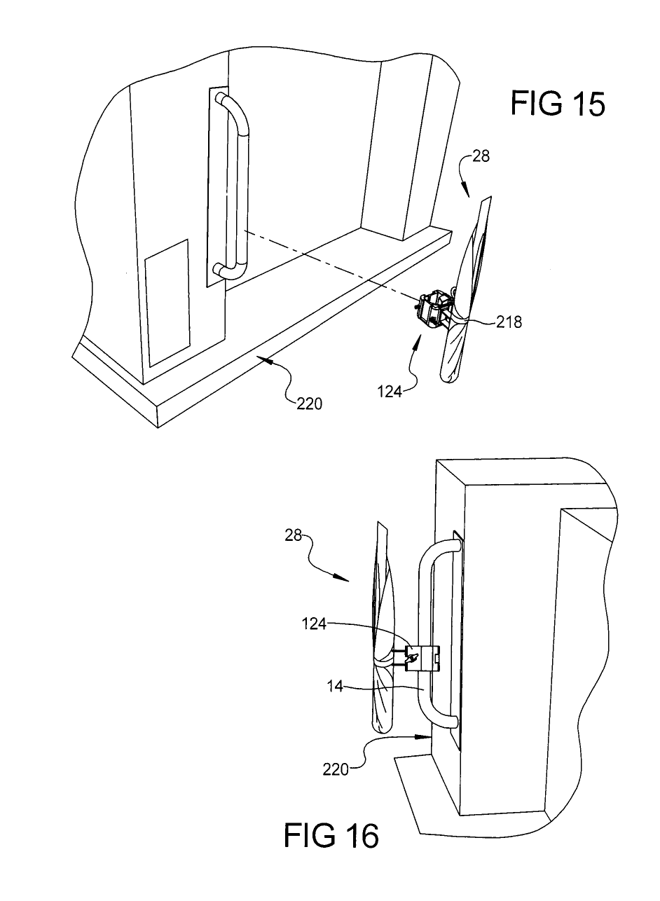

Referring to FIG. 16, a fully assembled condition of third clamp assembly 124 is shown having third clamp assembly 124 frictionally engaged with bar 114 which is connected to vehicle 220. Sign assembly 28 is shown in its stowed position which would be the normal transport position when vehicle 220 is operated.

Referring to FIG. 17, when vehicle 220 reaches an operating area, sign assembly 28 can be unfolded and extended to a fully deployed position shown.

Referring to FIG. 18, vehicle 220 is shown as a fire engine in a typical parked position at an emergency site. Sign assembly 28 is shown in its fully deployed position graphically displaying to other vehicles a message informing other vehicles of the presence of vehicle 220.

A grab bar sign holder assembly of the present disclosure offers several advantages. By either releasably or fixedly clamping a sign assembly to a vehicle such as to a grab bar or similar bar connected to the vehicle, the sign assembly can be permanently or semi-permanently positioned on the vehicle in either a stowed or fully deployed position without having to move the sign assembly or stow the sign assembly when not in use. This frees additional storage space on the vehicle and also has the benefit of always positioning the sign assembly where it is optimally useful, for example at a required or recommended height or orientation with respect to the vehicle. The various clamp assemblies of the present disclosure also provide alternative permanent or releasable clamping forces to retain the sign assembly on the vehicle. Also, if desired, the clamp assemblies of the present disclosure together with the sign assemblies can be removed from the vehicle if required for replacement or to repair damage to the sign assembly.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A sign mounting system, comprising:
a clamp assembly, including:
first and second clamp members, the second clamp member rotatable toward and away from the first clamp member permitting first and second jaw members each connected to one of the first and second clamp members to releasably grip a fixed member when the second clamp member is rotated toward the first clamp member; and
a structural member fixedly connected to the first clamp member; and
a sign assembly, including:
a support frame having the at least one structural member connected to the support frame;
a sign frame member slidably received in and releasably engaged to the support frame, the sign frame member connected to a sign; and
a fastener received through the support frame, the sign frame slidingly contacting the fastener defining a stop point for insertion of the sign frame.

2. The system of claim 1, wherein the clamp assembly further includes a threaded locking member operating to displace the movable clamp member toward and away from the fixed clamp member and to releasably hold the movable clamp member at a position with respect to the fixed clamp member.

3. The system of claim 2, wherein the locking member includes a threaded engagement portion threadably received in both the fixed and movable clamp members that when rotated threadably moves the movable clamp member toward or away from the fixed clamp member.

4. The system of claim 1, wherein the support frame includes opposed first and second extending walls defining a frame member receiving slot therebetween, the sign frame having a body shaped to be slidably fit within the frame member receiving slot and retained by the first and second extending walls.

5. The system of claim 4, wherein the fastener is received through each of the first and second extending walls proximate one end of the support frame and extends through the frame member receiving slot defining the stop point for insertion of the sign frame.

6. The system of claim 1, wherein in a clamped condition of the first and second jaw members to the fixed member, the support frame and the sign frame are non-rotatably connected to the fixed member permitting the sign to be oriented in a fixed orientation with respect to the fixed member.

7. The system of claim 1, further including a pin rotatably connecting the first and second clamp members such that the second jaw member is rotatable about the pin with respect to the first jaw member.

8. A system for mounting a sign to a vehicle, comprising:
a bar connected to the vehicle;
a clamp assembly releasably connected to the bar, including:
first and second jaw members adapted to frictionally engage the bar between the first and second jaw members;
first and second clamp members each having one of the first and second jaw members fixedly connected thereto;
at least one structural member fixedly connected to the first clamp member, the second clamp member rotatable with respect to the first clamp member; and
a locking member operating to displace the second clamp member toward and away from the first clamp member and releasably lock the second clamp member in position; and
a sign assembly, including:
a support frame having the at least one structural member connected to the support frame; and
a frame member slidably received and releasably engaged to the support frame.

9. The system of claim 8, wherein the clamp assembly further includes a pin, the second clamp member rotatably connected to the second jaw member by the pin.

10. The system of claim 9, wherein the locking member includes a threaded engagement portion threadably received in both the first and second clamp members that when rotated threadably moves the second clamp member toward or away from the first clamp member.

11. The system of claim 10, further including an elongated aperture created in the first clamp member receiving the threaded engagement portion of the locking member allowing the threaded engagement member to displace angularly as the second clamp member rotates with respect to the first clamp member.

12. The system of claim 8, further including a sign connected to the frame member positionable in each of a stowed and a deployed position, the deployed position fixedly oriented with respect to the bar when the first and second jaw members are clamped to the bar.

13. The system of claim 8, wherein the support frame includes first and second extending walls defining a receiving slot therebetween, the frame member slidably received between the first and second extending walls and within the receiving slot and slidable to a stopped position created by a fastener inserted through both the first and second extending walls and positioned within the receiving slot.

14. The system of claim 8, wherein each of the first and second jaw members include a substantially V-shaped body having curved inner facing wall segments that diverge into first and second concave transition portions, providing at least two points of contact between each of the first and second jaw members and the bar in a bar clamped condition.

15. A system for mounting a sign to a vehicle, comprising:
a bar connected to the vehicle;
a clamp assembly, including:
first and second jaw members coupled to each other to frictionally engage the bar between the first and second jaw members; and
a structural member supporting the first jaw member, the second jaw member releasable with respect to the first jaw member;
a sign assembly, including:
a support frame having the structural member connected to the support frame, the support frame including opposed first and second extending walls defining a frame member receiving slot therebetween; and
a frame member slidably received within the frame member receiving slot to releasably engage the frame member to the support frame; and
a mounting flange fixedly connected to the structural member and releasably connected to the support frame.

16. The system of claim 15, wherein the sign frame includes a body shaped to be slidably fit within the frame member receiving slot and retained by the first and second extending walls.

17. The system of claim 16, further including a fastener received through each of the first and second extending walls proximate one end of the support frame and extending through the frame member receiving slot, the sign frame contacting the fastener defining a stop point for insertion of the sign frame.

18. The system of claim 15, further including at least one fastener releasably engaging the second jaw member to the first jaw member to frictionally engage the bar between the first and second jaw members.

19. The system of claim 15, further including:
a sign connected to the frame member positionable in each of a stowed and a deployed position, the deployed position fixedly oriented with respect to the bar when the first and second jaw members are clamped to the bar; and
a flexible sign strap attached to the sign and adapted to wrap about the sign and the frame member to secure the sign to the frame member in the stowed position.

20. The system of claim 15, wherein the mounting flange is welded to the structural member and fastenably connected to the support frame.
